(19) United States
(12) Patent Application Publication
(10) Pub. No.: US 2015/0162009 A1
(43) Pub. Date: Jun. 11, 2015

(54) ANALYSIS SYSTEM AND METHOD THEREOF

(71) Applicant: National Central University, Jhongli City (TW)

(72) Inventors: Norden. E. Huang, Jhongli City (TW); Bo-Jau Kuo, Taipei (TW); Yu-Cheng Lin, Taipei (TW); Chung-Kang Peng, Sharon, MA (US); Men-Tzung Lo, Jhongli City (TW)

(73) Assignee: National Central University, Jhongli City (TW)

(21) Appl. No.: 14/273,082

(22) Filed: May 8, 2014

(30) Foreign Application Priority Data
Dec. 10, 2013 (TW) 102145345

(51) Int. Cl. G10L 19/00

(52) U.S. Cl. CPC G10L 19/00

(57) ABSTRACT

The present invention provides an analysis system adapted for processing a signal with a time period. The analysis system comprises a segmenting unit, an analyzing unit, processing unit and an outputting unit. The segmenting unit divides the signal into a plurality of scale windows according to one of interval scales. The analyzing unit processes the scale windows via HHT algorithm to make each scale window generate a plurality of quantized windows according to different components. The processing unit reorganizes the quantized windows make each scale window generate a plurality of quantized windows according to different components. The outputting unit accumulates a plurality of specific frequency values in difference interval scales and combines the specific frequency values to form a three-dimensional variation visual diagram.

### CROSS-REFERENCE TO RELATED APPLICATIONS

This Non-provisional application claims priority under 35 U.S.C. §119(a) on Patent Application No(s). 102145345 filed in Taiwan, Republic of China on Dec. 10, 2013, the entire contents of which are hereby incorporated by reference.

### FIELD OF THE INVENTION

The invention relates to an analysis system and, more particularly, to an analysis system can generate a three-dimensional variation visual diagram.

### BACKGROUND OF THE INVENTION

As technology advances, more and more detectors are used to detect physiological signal, which can provide users detecting their physical condition by themselves. However, the physiological signals detected by the detectors are various and complex, and the information measured for each time cannot be collated in a systematic way. The users only can know the current physical condition, but cannot know individual overall trend toward and changes physiological parameters.

The conventional technology has provided some health management systems, but almost of them are off-line analysis systems. The conventional health management systems are not only relatively large and complex, but also need professional human operations to analyze, so the cost is high and it requires more manpower and time consuming.

### SUMMARY OF THE INVENTION

The present invention provides an analysis system adapted to process a signal, and the signal includes a time period. The analysis system includes a segmenting unit, an analyzing unit, a processing unit, and an outputting unit.

The segmenting unit of the invention divides the time period into a plurality of scale windows according to one of interval scales. The time period can be divided by any one of interval scales, which is not limited herein.

The analyzing unit of the invention processes the scale windows via Hilbert Huang transform (HHT) algorithm to make each scale window generate a plurality of quantized windows according to different components. In a preferred embodiment, the components are composed of a plurality of single-frequency components.

The processing unit of the invention respectively reorganizes the quantized windows with the same component to generate a plurality of specific frequency values based on the components. Finally, the outputting unit of the invention accumulates the specific frequency values of difference interval scales and combines the specific frequency values to form a three-dimensional variation visual diagram.

The present invention also provides an analysis method, and the steps are as follows:

Step 1. A signal with a time period is provided.

Step 2. The time period is divided into a plurality of scale windows according to one of interval scales.

Step 3. The scale windows are processed via HHT algorithm to make each scale window generate a plurality of quantized windows according to different components. The HHT algorithm comprises empirical mode decomposition (EMD) method, which is not limited herein.

Step 4. The quantized windows with the same component are reorganized to generate a plurality of specific frequency values.

Step 5. Step 1. to Step 4. are executed repeatedly. The specific frequency values of difference interval scales are accumulated and the specific frequency values are combined to form a three-dimensional variation visual diagram.

The analysis system and method of the invention can be provided as an automated health management system through comparing the indicators generated after processing the signals and health indicators measured. The signals measured by personal health detectors can be automatically uploaded to the server wirely or wirelessly to analyze, either directly analyzed by individual client. All records and information are stored and applied EMD method of Hilbert transform method to decompose the complex signals into different components and non-oscillation trends. The components are a plurality of intrinsic mode functions (IMFs). In a preferred embodiment, the components are a plurality of single-frequency components. The non-oscillation trend is a non-oscillation residue. The intrinsic mode functions (IMFs) decomposed can be as fluctuations information of physiological parameters in these days, weeks or months. The non-oscillation residue has ruled out the influence of the transient noise or temporary fluctuations, therefore the non-oscillation residue can be used as individual overall trend toward and changes physiological parameters, so that users can effectively get their physical condition and related information.

### BRIEF DESCRIPTION OF THE DRAWINGS

The patent or patent application file contains at least one drawing executed in color. Copies of this patent or patent application publication with color drawing(s) will be provided by the Office upon request and payment of the necessary fee.

FIG. 1 shows a diagram of the analysis system in the invention.

FIG. 2 shows a diagram of a first embodiment of the signal segmented in the invention.

FIG. 3A to FIG. 3D respectively show diagrams of the scale window generating a plurality of quantized windows according to different components in the invention.

FIG. 4A to FIG. 4C respectively show diagrams of the quantized windows with the same component being reorganized to generate a plurality of specific frequency values.

FIG. 5 shows a diagram of a second embodiment of the signal segmented in the invention.

FIG. 6 shows a three-dimensional variation visual diagram of accumulating the specific frequency values of the first embodiment and the second embodiment of the invention.

FIG. 7 shows a diagram of the analyzing system applied to a remote device (a server) in the invention.

FIG. 8 shows a flow chart of the analysis method in the invention.

FIG. 9A shows a signal diagram of blood pressure collected for 500 days (signal TS).

FIG. 9B shows a three-dimensional color-level-variation visual diagram with indicators of different time, different scale windows and slope.

FIG. 9C shows a three-dimensional color-level-variation visual diagram with indicators of different time, different scale windows and difference.

FIG. 9D shows a three-dimensional color-level-variation visual diagram with indicators of different time, different scale windows and stability (standard deviation).

FIG. 9E shows a three-dimensional color-level-variation visual diagram with indicators of different time, different scale windows and deviation.

### DETAILED DESCRIPTION OF THE INVENTION

For clarity of disclosure, and not by way of limitation, the detailed description of the invention is divided into the subsections that follow.

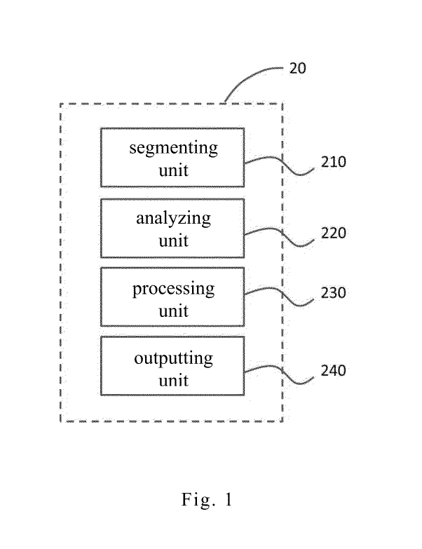

Please refer to FIG. 1 showing a diagram of the analysis system in the invention. The analysis system 20 is adapted to process a signal TS, and the signal TS includes a time period T. The analysis system 20 includes a segmenting unit 210, an analyzing unit 220, a processing unit 230, and an outputting unit 240.

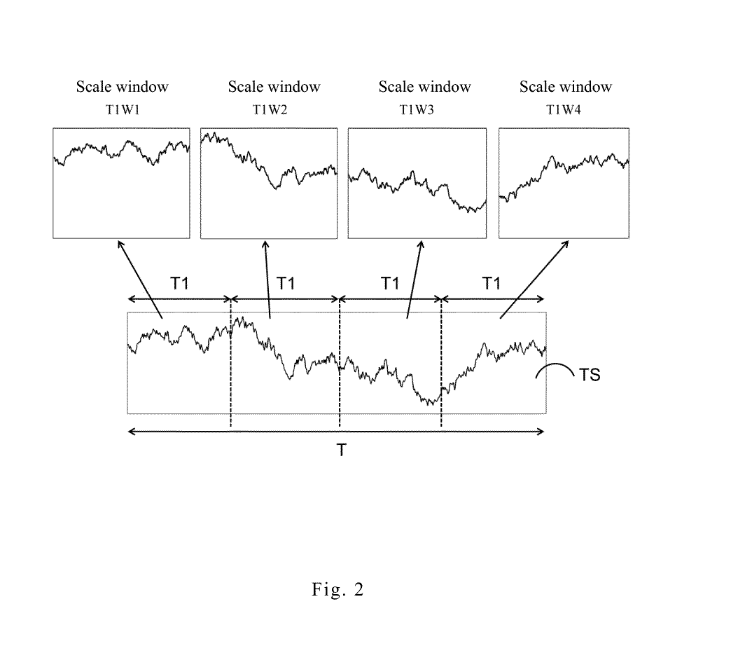

Please refer to FIG. 2 showing a diagram of a first embodiment of the signal segmented in the invention. The segmenting unit 210 of the invention divides the time period T into a plurality of scale windows according to one of interval scales. The time period T can be divided by any one of different interval scales. In an embodiment, the interval scale is T1. When the time period T is 600 seconds and the interval scale is T1 is 20 seconds, the time period T is divided into 30 scale windows. When the interval scale is T1 is 40 seconds, the time period T is divided into 15 scale windows, which is not limited herein.

Please refer to FIG. 2, in order to clearly describe the features of the invention, the time period T being divided into 4 scale windows by the interval scale T1 is taken as an example. The 4 scale windows are respectively a scale window T1W1, a scale window T1W2, a scale window T1W3 and a scale window T1W4, which is not limited herein.

The analyzing unit 220 of the invention processes the scale windows via Hilbert-Huang Transform (HHT) algorithm to make each scale window generate a plurality of quantized windows according to different components. In a preferred embodiment, the components are composed of a plurality of single-frequency components.

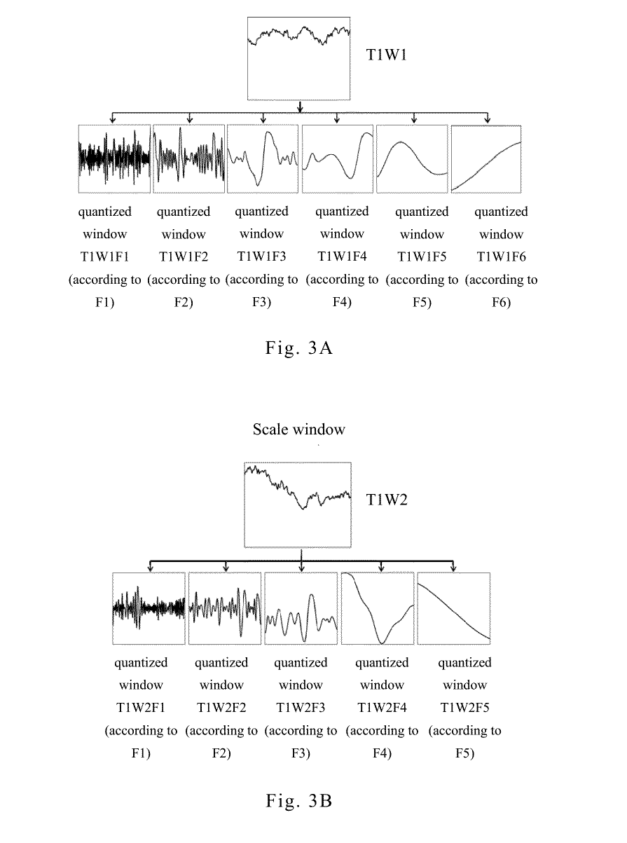

Please refer to FIG. 3A to FIG. 3D respectively showing diagrams of the scale window generating a plurality of quantized windows according to different components in the invention. As above embodiment, the scale window T1W1, the scale window T1W2, the scale window T1W3 and the scale window T1W4 are respectively processed to generate a plurality of quantized windows according to a first component F1, a second component F2, and a third component F3. For example, the scale window T1W1 is processed to generate a quantized window T1W1F1, a quantized window T1W1F2 and a quantized window T1W1F3 according to the three different components. The scale window T1W2 is processed to generate a quantized window T1W2F1, a quantized window T1W2F2 and a quantized window T1W2F3 according to the three different components, which is not limited herein.

The processing unit 230 of the invention respectively reorganizes the quantized windows with the same component to generate a plurality of specific frequency values based on the components.

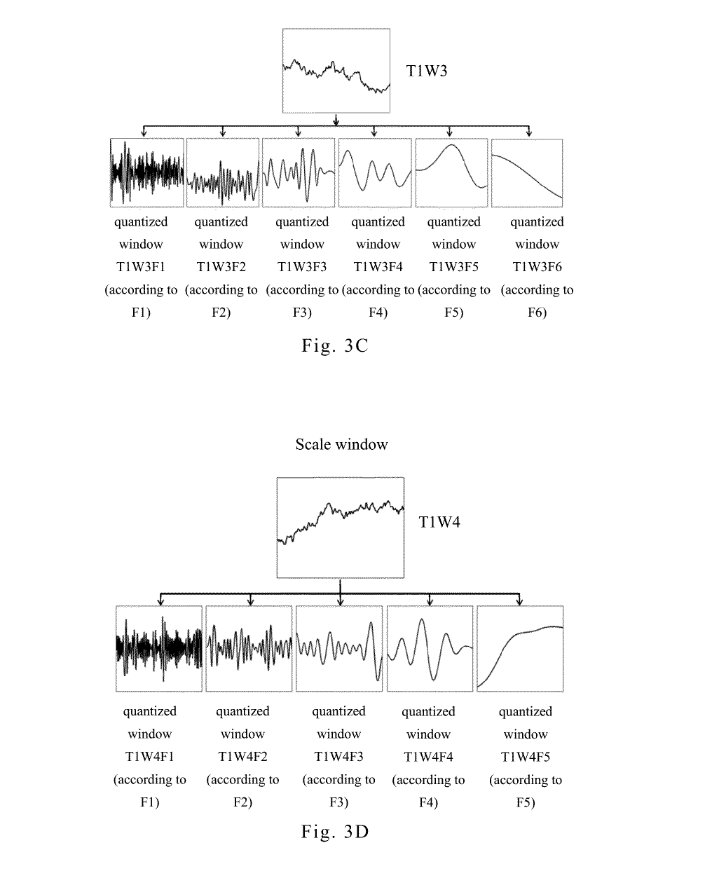

Please refer to FIG. 4A to FIG. 4C respectively showing diagrams of the quantized windows with the same component being reorganized to generate a plurality of specific frequency values. As above embodiment, in the situation based on the first component F1 to reorganize, a quantized window T1W1F1, a quantized window T1W2F1, a quantized window T1W3F1, and a quantized window T1W4F1 are selected from the quantized windows (the scale window T1W1, the scale window T1W2, the scale window T1W3 and the scale window T1W4) with the first component F1 to reorganize and further to generate a specific frequency value T1F1V. In the situation based on the second component F2 to reorganize, a quantized window T1W1F2, a quantized window T1W2F2, a quantized window T1W3F2, and a quantized window T1W4F2 are selected from the quantized windows (the scale window T1W1, the scale window T1W2, the scale window T1W3 and the scale window T1W4) with the second component F2 to reorganize and further to generate a specific frequency value T1F2V, which is not limited herein.

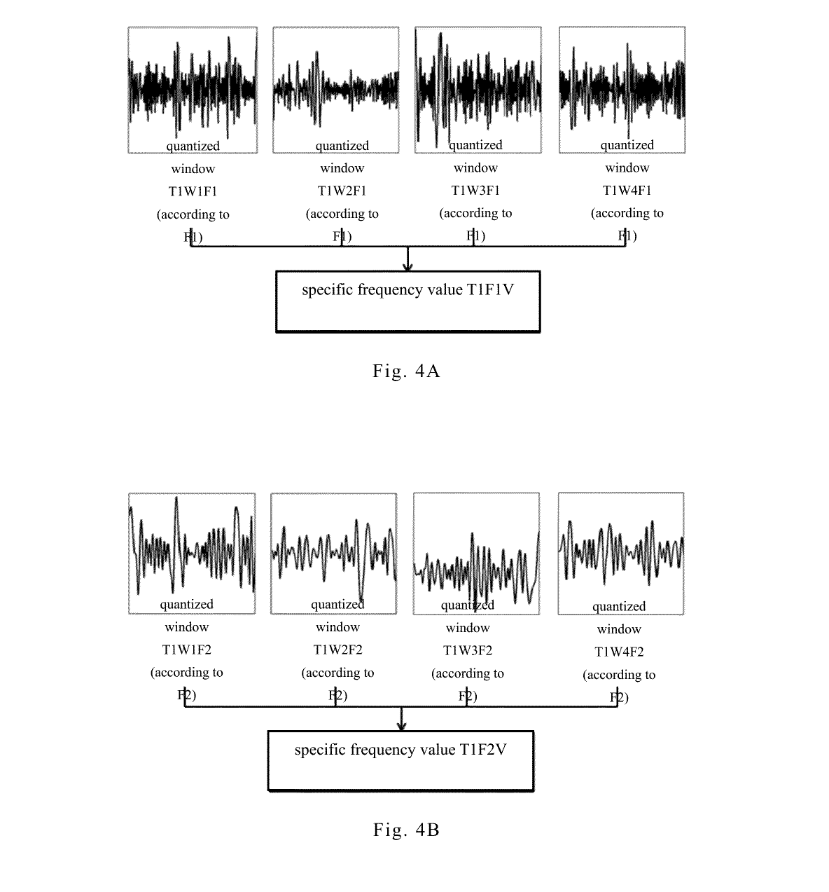

In another embodiment, please refer to FIG. 5 showing a diagram of a second embodiment of the signal segmented in the invention. The segmenting unit 210 dividing the time period T into 6 scale windows by the interval scale T2 is taken as an example. The 6 scale windows are respectively a scale window T2W1, a scale window T2W2, a scale window T2W3, a scale window T2W4, a scale window T2W5, and a scale window T2W6, which is not limited herein.

The analyzing unit 220 processes the scale window T2W1, the scale window T2W2, the scale window T2W3, the scale window T2W4, the scale window T2W5, and the scale window T2W6 to generate the quantized windows (T2W1F1, T2W1F2, T2W1F3, T2W1F4; T2W2F1, T2W2F2, T2W2F3, T2W2F4; T2W3F1, T2W3F2, T2W3F3, T2W3F4; T2W4F1, T2W4F2, T2W4F3, T2W4F4; T2W5F1, T2W5F2, T2W5F3, T2W5F4; T2W6F1, T2W6F2, T2W6F3, T2W6F4) respectively according to the first component F1, the second component F2, the third component F3, and the fourth component F4, which is not limited herein.

The processing unit 230 respectively reorganizes the quantized windows according to the first component F1, the second component F2, the third component F3, and the fourth component F4 to generate a plurality of specific frequency values(T2F1V, T2F2V, T2F3V, T2F4V), which is not limited herein.

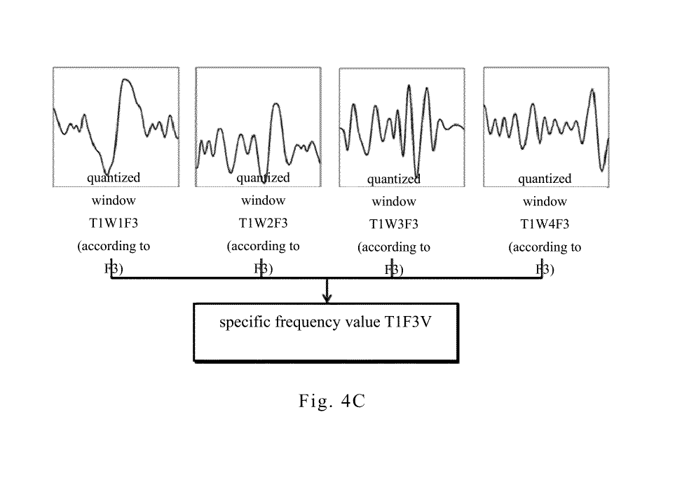

Finally, the outputting unit 240 of the invention accumulates the specific frequency values of difference interval scales and combines the specific frequency values to form a three-dimensional variation visual diagram. Please refer to FIG. 6 showing a three-dimensional variation visual diagram of accumulating the specific frequency values of the first embodiment and the second embodiment of the invention. As above embodiment, the outputting unit 240 accumulates the specific frequency values T1F1V, T1F2V and T1F3V of the first embodiment and the specific frequency values T2F1V, T2F2V, T2F3V, and T2F4V of the second embodiment to form the three-dimensional variation visual diagram, which is not limited herein.

In an embodiment, the outputting unit 240 includes an operating interface 241 to adjust the interval scales T or components, which is not limited herein.

In an embodiment, the signal TS can be a nonlinear or non-stationary data, such as physiology information of blood pressure, blood glucose, temperature, weight, or so on, which is not limited herein.

The HHT algorithm of the analyzing unit 220 comprises an Empirical Mode Decomposition (EMD) method which is an adaptive analysis method, and can also be said a regional wave decomposition method. The EMD method can decompose any complex raw data into a plurality of different single components and a non-oscillation trend by applying reasonable and concise manners. The single component is known as intrinsic mode function, and the non-oscillation trend is known as non-oscillation residue.

The characteristics of the intrinsic mode functions include a reasonable instantaneous frequency definition which can transform every component via Hilbert transform to generate the information of instantaneous frequency and instantaneous amplitude of each component. Then a time-frequency-energy spectrum can be obtained through mathematical computing. The time-frequency-energy spectrum includes good resolution whether in the time domain or in frequency domain. The three-dimensional distribution can reflect the essential characteristics of the signal. Frequency-amplitude spectral of two-dimensional can be obtained via the time integral of Hilbert spectrum.

HHT is a high efficient mathematical algorithm, it adjusts the baseline to analyze corresponding to changes of the data, and that is to say that HHT is adaptive to analyze or calculates the data changes over time, such as human-related physiological parameters. As a result, the analyzing system 20 of the invention can effectively and accurately process and analyze the data by using HHT, so as to make the results produced be more informative.

That is to say, the analyzing system 20 of the invention can continuously access the various types of signals. In one embodiment, the analyzing system 20 is applied to a proximal device or a remote device to process the signals TS, which is not limited herein.

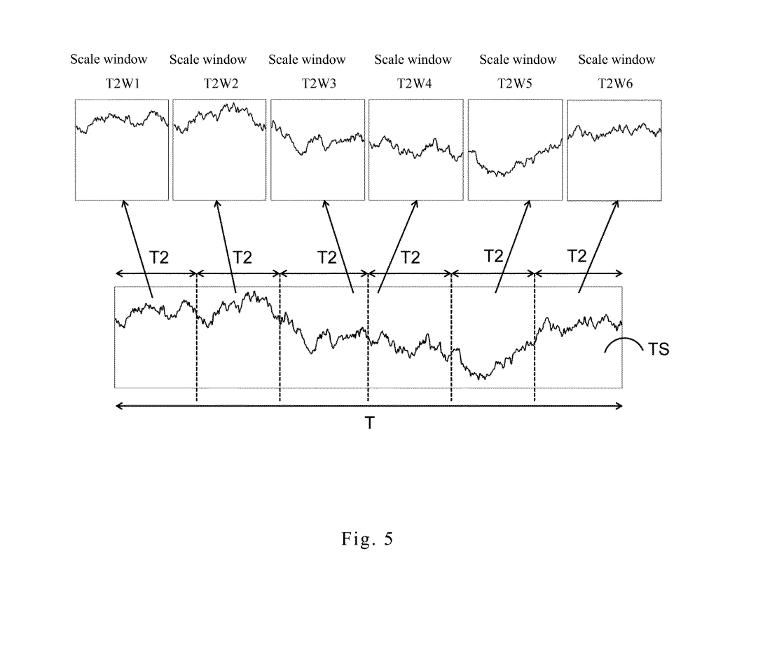

Please refer to FIG. 7 showing a diagram of the analyzing system applied to a remote device (a server) in the invention. The device provided signals TS can be any personal health detector 40, such as blood pressure meter, blood glucose meter, temperature meter or weight meter, which is not limited herein.

The analyzing system 20 of the invention can automatically upload the relevant physiological parameter data to the server 10 wirely or wirelessly. It can provide users automatic and comprehensive analysis services by automatic acquiring, storage and analysis via network cloud.

The physiological parameter data can be transferred to the segmenting unit 210 for subsequent processing via database 30 to. The database 30 not only can store the signal TS, but also can store any kinds of information processed according to signals TS, which is not limited herein.

The operating interface 241 of the outputting unit 240 can adjust the interval scales T or components to generate various three-dimensional variation visual diagrams. The three-dimensional variation visual diagram can be a three-dimensional color-level-variation visual diagram with a triangular form comprising information of different time, the different scale windows and the specific frequency values, and can be displayed by an outputting interface or transferred to network cloud for users observing or inquiry, which is not limited herein.

As above mentioned, the outputting interface is formed by a command line interface (CLI) or a graphical user interface (GUI), which is not limited herein.

As above mentioned, the HHT is adaptive to analyze or calculates the data changes over time, such as human-related physiological parameters. The EMD method can decompose any complex raw data into a plurality of different single components and a non-oscillation trend as valuable references. As a result, even the signal TS stored in the database 30 is nonlinear or non-stationary, the analyzing system 20 still can effectively and accurately process and analyze these data, so as to make the results produced be more informative.

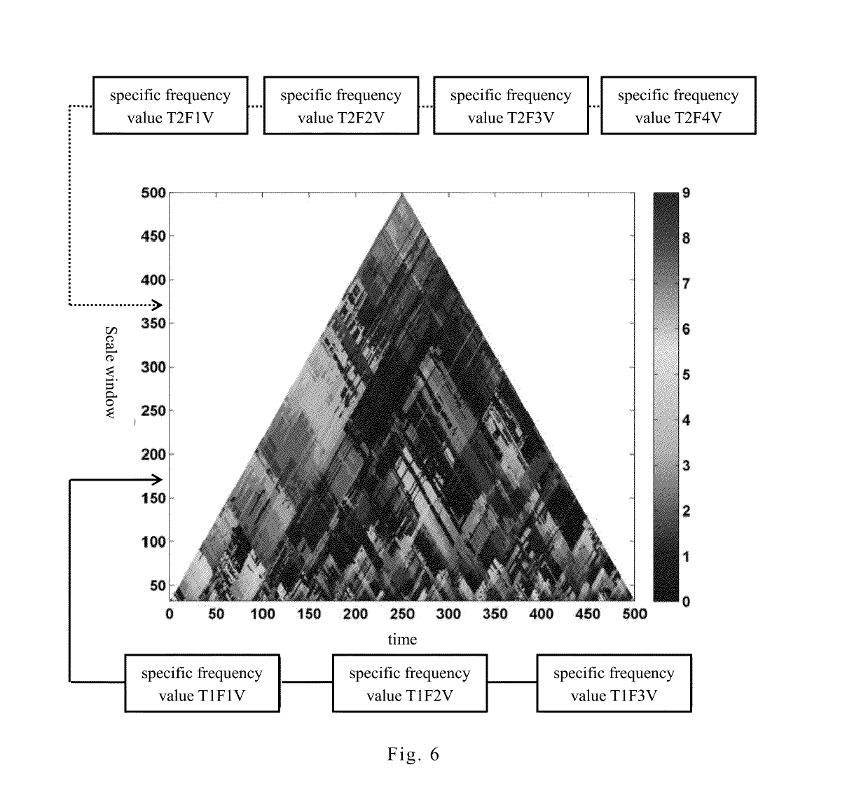

Please refer to FIG. 8 showing a flow chart of the analysis method in the invention, and the steps are as follows:

Step 1. A signal with a time period is provided.

Step 2. The time period is divided into a plurality of scale windows according to one of interval scales.

Step 3. The scale windows are processed via HHT algorithm to make each scale window generate a plurality of quantized windows according to different components. The HHT algorithm comprises EMD method, which is not limited herein.

Step 4. The quantized windows with the same component are reorganized to generate a plurality of specific frequency values.

Step 5. Step 1 to Step 4 are executed repeatedly. The specific frequency values of difference interval scales are accumulated and the specific frequency values are combined to form a three-dimensional variation visual diagram.

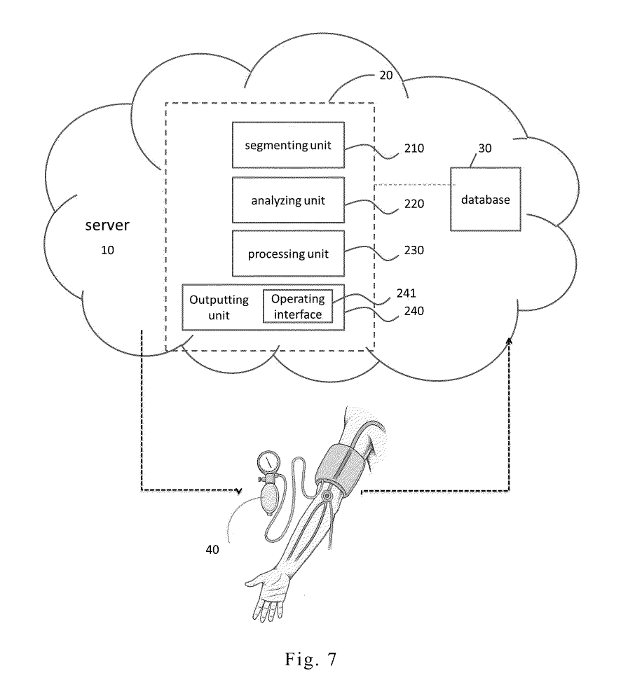

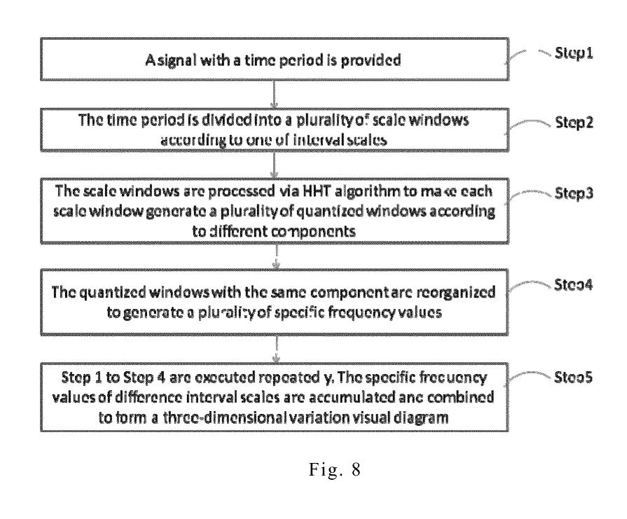

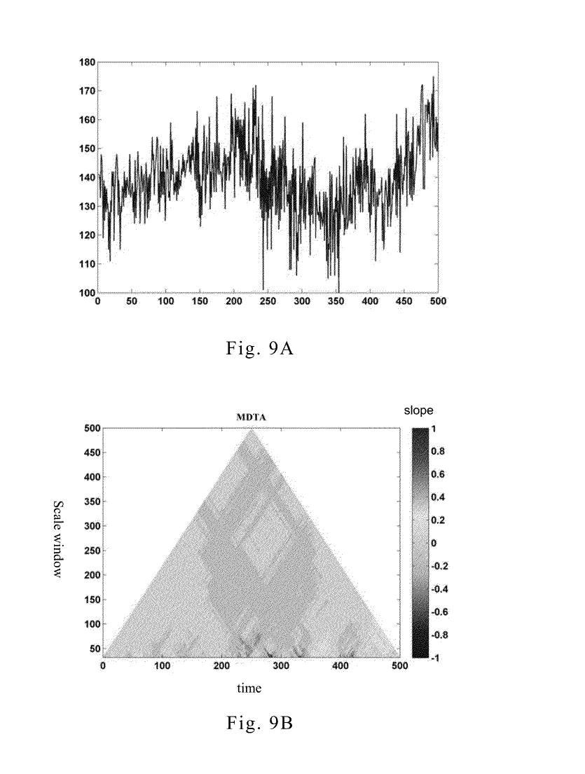

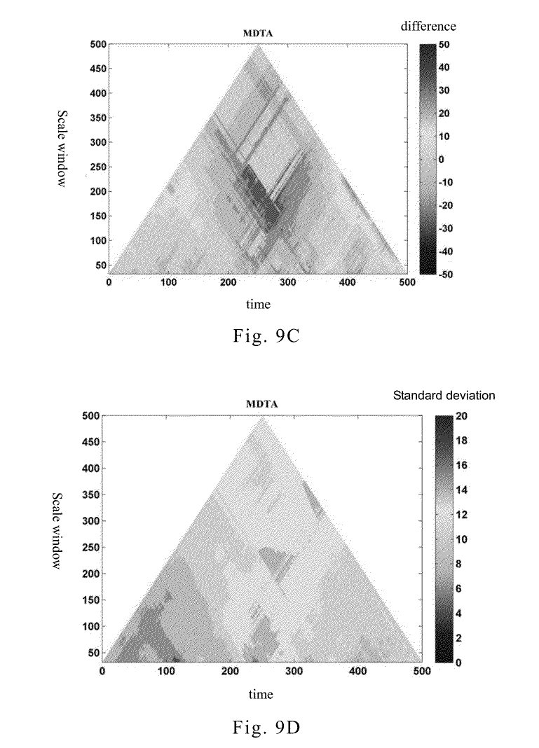

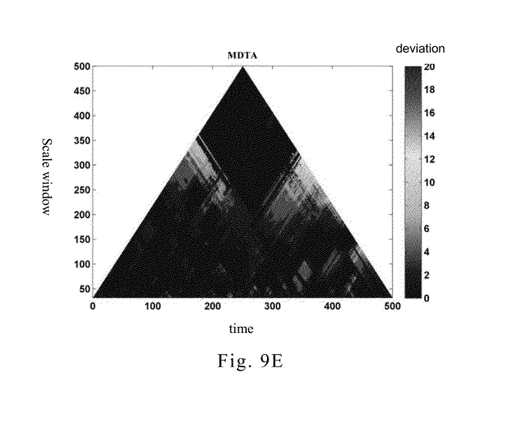

In an embodiment, please refer to FIG. 9A to FIG. 9E. FIG. 9A shows a signal diagram of blood pressure collected for 500 days (signal TS). FIG. 9B shows a three-dimensional color-level-variation visual diagram with indicators of different time, different scale windows and slope. FIG. 9C shows a three-dimensional color-level-variation visual diagram with indicators of different time, different scale windows and difference. FIG. 9D shows a three-dimensional color-level-variation visual diagram with indicators of different time, different scale windows and stability (standard deviation). FIG. 9E shows a three-dimensional color-level-variation visual diagram with indicators of different time, different scale windows and deviation.

The analysis system and method of the invention can be provided as an automated health management system through comparing the above indicators and health indicators measured. The signals measured by personal health detectors 40 can be automatically uploaded to the server wirely or wirelessly to analyze, either directly analyzed by individual client. All records and information are stored and applied EMD method of Hilbert transform method to decompose the complex signals into different components and a non-oscillation trends. The components are a plurality of intrinsic mode functions. In a preferred embodiment, the components are a plurality of single-frequency components. The non-oscillation trend is a non-oscillation residue. The intrinsic mode functions decomposed can be fluctuations information of physiological parameters in these days, weeks or months. The non-oscillation residue has ruled out the influence of the transient noise or temporary fluctuations, therefore the non-oscillation residue can be used as individual overall trend toward and changes physiological parameters, so that users can effectively get their physical condition and related information.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. An analysis system, adapted for processing a signal with a time period, and the analysis system comprising:
a segmenting unit, dividing the time period into a plurality of scale windows according to one of interval scales;
an analyzing unit, processing the scale windows via Hilbert-Huang Transform (HHT) algorithm to make each scale window generate a plurality of quantized windows according to different components;
a processing unit, respectively reorganizing the quantized windows with the same component to generate a plurality of specific frequency values; and
an outputting unit, accumulating the specific frequency values of difference interval scales and combining the specific frequency values to form a three-dimensional variation visual diagram.

2. The analysis system according to claim 1, wherein the components are composed of a plurality of single-frequency components.

3. The analysis system according to claim 1, wherein the HHT algorithm comprises an Empirical Mode Decomposition (EMD) method.

4. The analysis system according to claim 1, wherein the three-dimensional variation visual diagram is a three-dimensional color-level-variation visual diagram with a triangular form.

5. The analysis system according to claim 4, wherein the three-dimensional color-level-variation visual diagram with a triangular form comprises information of different time, the different scale windows and the specific frequency values.

6. The analysis system according to claim 1, wherein the signal is a nonlinear or non-stationary data.

7. The analysis system according to claim 6, wherein the nonlinear or non-stationary data is physiology information.

8. The analysis system according to claim 1, the signal is processed by a remote device or a proximal device.

9. An analysis method, comprising:
Step 1. providing a signal with a time period;
Step 2. dividing the time period into a plurality of scale windows according to one of interval scales;
Step 3. processing the scale windows via HHT algorithm to make each scale window generate a plurality of quantized windows according to different components;
Step 4. reorganizing the quantized windows with the same component to generate a plurality of specific frequency values; and
Step 5. repeating the Step 1 to Step 4, and accumulating the specific frequency values of difference interval scales and combining the specific frequency values to form a three-dimensional variation visual diagram.

10. The analysis method according to claim 9, wherein the components are composed of a plurality of single-frequency components.

11. The analysis method according to claim 9, wherein the three-dimensional variation visual diagram is outputted by an outputting interface.

12. The analysis method according to claim 11, wherein the outputting interface is formed by a command line interface (CLI) or a graphical user interface (GUI).

13. The analysis method according to claim 9, wherein the HHT algorithm comprises an Empirical Mode Decomposition (EMD) method.

14. The analysis method according to claim 9, wherein the signal is a nonlinear or non-stationary data.

15. The analysis method according to claim 14, wherein the nonlinear or non-stationary data is physiology information.

16. The analysis method according to claim 9, the signal is processed by a remote device or a proximal device.
